(19) United States
(12) Patent Application Publication
(10) Pub. No.: US 2010/0131876 A1
(43) Pub. Date: May 27, 2010

(54) ABILITY TO CREATE A PREFERRED PROFILE FOR THE AGENT IN A CUSTOMER INTERACTION EXPERIENCE

(75) Inventors: Frank MCGUIRE, Galway (IE); John COSTELLO, Galway (IE); David MURRAY, Galway (IE); Martin WALKER, Galway (IE)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED, Saint-Laurent (CA)

(21) Appl. No.: 12/275,502

(22) Filed: Nov. 21, 2008

(51) Int. Cl. G06F 3/048

(52) U.S. Cl. 715/765; 715/848

(57) ABSTRACT

A dynamic user interface for a method and system for creating, selecting, and adapting a virtual contact center within a virtual world. A user's interaction with the virtual world is evaluated and one or more environmental characteristics established based on the user's interaction with the virtual world. A virtual contact center having the one or more environmental characteristics is provided based on the user's interaction with the virtual world. The virtual contact center may include one or more environmental characteristics that are updateable in real-time to incorporate the user's preferences and selections within the virtual world.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to virtual reality worlds, and in particular to a method and system for creating, selecting, and adapting the environment of a virtual reality contact center using a dynamic user interface.

### BACKGROUND OF THE INVENTION

Virtual reality communities provide a useful three-dimensional social networking interface that allows their users, known as residents, to interact with each other for social, entertainment, and business purposes. A virtual reality world, known as a metaverse, includes many characteristics of a real world environment, including buildings, roads, landscaping, weather, sights, sounds, and diverse groups of residents. The residents interact with each via their three-dimensional virtual images, known as avatars, providing an advanced interface for communication, mobility, and interaction with other residents in the virtual world. Residents can explore the metaverse, participate in virtual activities, create, buy, and sell goods, as well as provide services to other residents and groups in the virtual community.

In one virtual reality world, known as Second Life®, resident avatars typically have human characteristics. That is, avatars may be sized proportionally to the virtual environment and may have diverse features such as different clothes, weight, height, facial appearances, color, and other features that distinguish the avatars from one another. Traditionally, a resident selects an avatar from a stored database of avatars and uses that avatar to interact with the other residents. The avatars are typically monotone, and do not reflect the tone, mood, or experience of the resident. As such, when two or more avatars are communicating in Second Life®, the audible aspects of the communication are devoid of the emotions and experience of the residents.

The economy of Second Life® is conducted like real life commercial markets. Residents can buy or sell virtual goods, own virtual land, offer virtual services, and bargain. Virtual commercial establishments, known as contact centers, are locations where resident customers conduct business with each other via one or more avatars that operate the contacts centers. A contact center can also be any place a resident goes, whether to a bank, grocery store, or library. When a customer enters into a virtual contact center, the environment is pre-selected by the proprietor of contact center. For example, the design of the contact center, from the color of the walls, to the appearance of the waiting room seats, and even the customer service representative avatar, are all pre-selected by the contact center. As such, contact centers offer the same experience to every customer, regardless of their individual preferences.

Virtual contact centers also fail to provide personalized services to their virtual customers that are responsive to their individual needs and preferences. For example, a customer who is dissatisfied with a contact center service will receive the same experience from a customer service avatar as would a satisfied customer. Moreover, virtual contact centers also lack a dynamic environment that recalls the past experiences of their customers and adapts to their preferences, the result is that virtual contact centers fail to provide personalized service based on a customer's purchase history, avatar preferences, and overall contact center experience.

Therefore, what is needed is a system and method for creating, selecting, and adapting the customer representative, as well as the overall environment of a virtual contact center, based on a customer's preferences. Additionally, a method and system is needed that dynamically changes the environment of the contact center based upon a customer's preferences and past experiences, to offer personalized service at virtual contact centers.

### SUMMARY OF THE INVENTION

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description

In accordance with an aspect, the present invention provides a system for creating, selecting, and adapting the environment of a virtual reality contact center using a dynamic user interface. The system includes a central processing unit operating to provide a virtual world having a virtual contact center. A database is in operative communication with the central processing unit to store one or more established environmental characteristics based on a user's interactions with the virtual world. The central processing unit and the database further operate to present the virtual contact center having the one or more established environmental characteristics based on a user's interactions with the virtual world.

In accordance with another aspect, the present invention provides a method for creating, selecting, and adapting the environment of a virtual reality contact center using a dynamic user interface. The method includes evaluating a user's interaction with a virtual world. One or more environmental characteristics are established based on this interaction. A virtual contact center is provided having the one or more environmental characteristic based on the user's interaction with the virtual.

In accordance with yet another aspect, the present invention provides a method creating, selecting, and adapting the environment of a virtual reality contact center using a dynamic user interface. The method includes evaluating a first user interaction with a virtual world. One or more environmental characteristics are established based on this first interaction. A second interaction with the virtual world is evaluated. The one or more environmental characteristics are updated based on the second interaction with the virtual world. A virtual contact center is provided having the updated one or more environmental characteristics.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary dynamic virtual contact center system constructed in accordance with the principles of the present invention;

FIG. 2 is an illustration of an avatar outside a virtual contact center within a virtual world;

FIG. 3 is the illustration of FIG. 2 with an environmental characteristic of the virtual world;

FIG. 4 is the illustration of FIG. 3 with the avatar and the environmental characteristic inside the virtual contact center;

FIG. 5 is a flow chart of an exemplary method for creating a virtual dynamic contact center in accordance with the principals of the present invention; and

FIG. 6 is a flow chart of an exemplary method of establishing one or more environmental characteristics.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for creating a dynamic virtual contact center. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

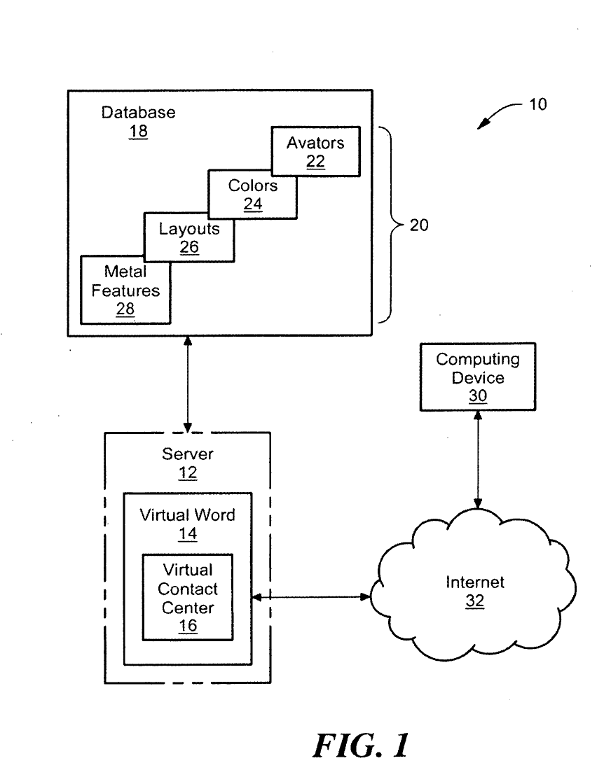

Referring now to the drawings in which like reference designators refer to like elements, there is shown in FIG. 1 a block diagram of an exemplary embodiment of the dynamic virtual contact system in accordance with the principals of the present invention and designated generally as “10”. The system 10 may include a server 12 inoperative communication with the various components of the invention discussed herein. The server 12 may be a central processing using such as computer, or any device that provides services such as accessing data files, programs, and peripheral devices. The server 12 may be in communication with a virtual world 14, which may be any two or three dimensional social or economic interface that allows virtual world 14 users to interact with each other. Virtual worlds 14 may exist and operate independently on one or more networks. It is therefore contemplated that the server 12 may communicate independently to separately implement each virtual world 14 or collectively to two or more virtual worlds 14. The virtual world 14 may include a virtual contact center 16, which are locations where virtual world 14 users conduct business with each other. The virtual contact center 16 may also be any place, for example, a bank, grocery store, or library, where users interact with each other and with the virtual contact center 16. The virtual contact center 16 need not be limited to a three-dimensional virtual structure, such as building or office, but may be any location involving a point of sale or customer service transaction between users in the virtual world 14.

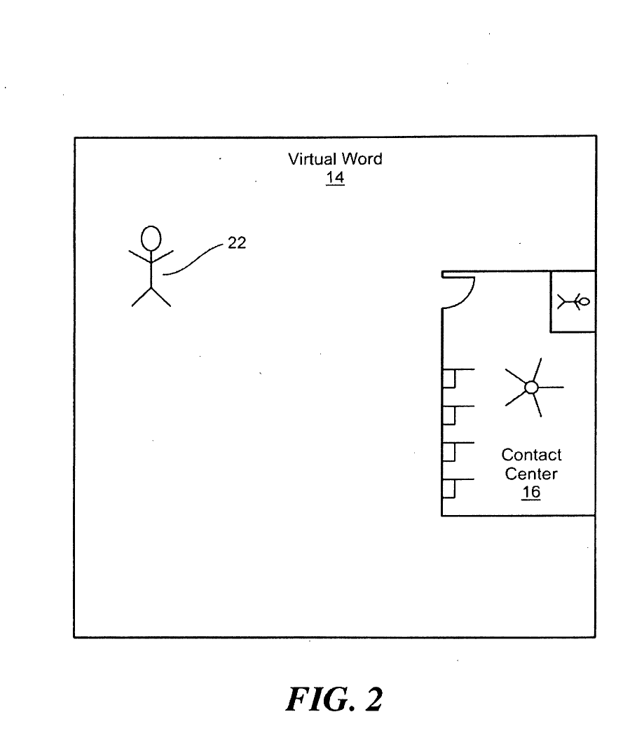

Continuing to refer to FIG. 1, the server 12 may further be in communication with a database 18. The database 18 may be a computer with a hard-drive or other storage device that can store or update graphical data. Although not shown in FIG. 1, in other embodiments, the database 18 may be integrated as part of the server 12. The database 18 may be directly connected to the server 12 or may be connected indirectly through an analog or digital network. The database 18 operates to store or update the one or more established environmental characteristics 20 based on a user's interaction with the virtual world 14. For example, the one or more established environmental characteristics 20 may include, but are not limited to, avatars 22, colors 24, layouts 36, and virtual features 28 of the virtual world 14 that a user may select or prefer based on the user's experience with the virtual world 14. For example, a user may prefer or select that the virtual contact center 16 have blue walls. These one or more established environmental characteristic 20 may then be stored in the database 18 in a file or table that stores the colors 24. The one or more established environmental characteristics 20 may also be updated if the user's preference or selections with the virtual world 14 change. The server 12 may then store and access these established environmental characteristics 20 in real-time and dynamically as the user interacts with the virtual world 14, discussed below with reference to FIGS. 2-6.

Continuing to refer to FIG. 1, a computing device 30 may also be included as part of system 10. The computing device 30 may be a computer, PDA, or any other electronic device capable of connecting and communicating with the Internet 32. A particular computing device 30 may be identified on the Internet 32 or server 12 by a transmission control protocol/internet protocol (“TCP/IP”), MAC address, or user name, such that the user may be identified separately from or with a particular computing device 30. The computing device 30 may indirectly or directly communicate with the server 12 through the Internet 32. This enables two-way communication between the computing device 30 and the server 12 when the computing device interacts with the virtual world 14 and the virtual contact center 16. For example, the server 12 may communicate with the computing device 30 and by sending information from the virtual world 14 and the virtual contact center 16 through the Internet 32. As the user dynamically operates and navigates the virtual world 14 and the virtual contact center 16 through the computing device 30, the server 12 may communicate the user's established environmental characteristics 20 to the database 18. The database 18 may then associate a particular computing device 30 or user with a stored dataset of established environmental characteristics 20. The server 12 communicates the established environmental characteristics 20 for a particular computing device 30 or user to the virtual world 14 and virtual contact center 16, instructing the virtual world 14 and virtual contact 16 to dynamically update virtual features 28 to incorporate the one or more established environmental characteristics 20.

Operation of the present invention is described with reference to FIGS. 2-4. FIG. 2 is an illustration of an exemplary avatar 22 in the virtual world 14. The avatar 22 represents the virtual image of the user, which may be selected by the user before entering the virtual world 14. As the user navigates the virtual world 14, the user's avatar 22 interacts with other users' avatars 22 and various virtual features 28 of the virtual world 14. In the example shown in FIG. 2, an avatar 22 is seen navigating the virtual world 14 proximate a virtual contact center 16. As shown, the virtual contact center 16 is a building with a ceiling fan, chairs, and customer service representative or agent behind a desk. The features of the virtual contact center 16 may be predetermined and initialized by the server 12 based on default features pre-established before the user enters the virtual contact center 16. Alternatively, the virtual contact center 16 may be initialized by incorporating the established environmental characteristics 20 based on the user's interaction with the virtual world 14.

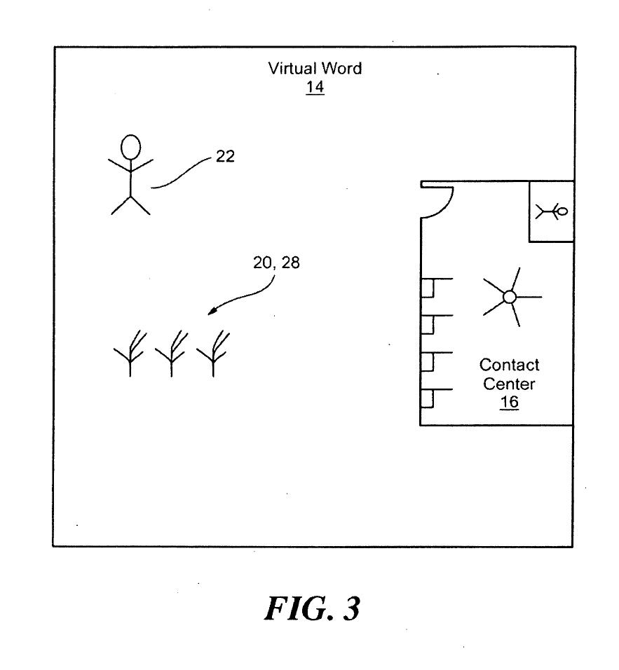

For example, as shown in FIG. 3, the user may encounter plants while navigating the virtual world 14. The user may communicate with other users that he prefers those plants, he may attempt to purchase the plants from another virtual contact center 16 (not shown), or otherwise indicate that he prefers those plants to trigger a response from the server 12. The response from the server 12 may include establishing an environmental characteristic 20 related to the plants and sending the established environmental characteristic 20 to the database 18.

The level of interest or preference that a user shows for a particular environmental characteristic 20 that may trigger a response from the server 12 may be variable. The server 12 response may be based on a pre-determined threshold, a dynamic threshold, or may be triggered by a user's selection. For example, when interacting with the plants, the server 12 may prompt the user as to whether the user would like to store the plants as an established environmental characteristic 20. The server 12 may also prompt the user to select environments where the user would like the plants to appear, such as a virtual contact center 16. Alternatively, the user may show sufficient interest in the plants, such that the server 12 establishes an environmental characteristic 20 without prompting the user for a selection.

Additionally, the established environmental characteristics 20 are not limited to visible virtual features 28 of the virtual world 14. For example, the environmental characteristics 20 may include the mood or tone of a customer service agent avatar 22. The user may prefer a customer service agent avatar in the virtual contact center 16 that speaks in a certain tone or calls the user by a certain name. The server 12 may store such environmental characteristics 20 in the database 18 and update the virtual contact center 16 to incorporate these features.

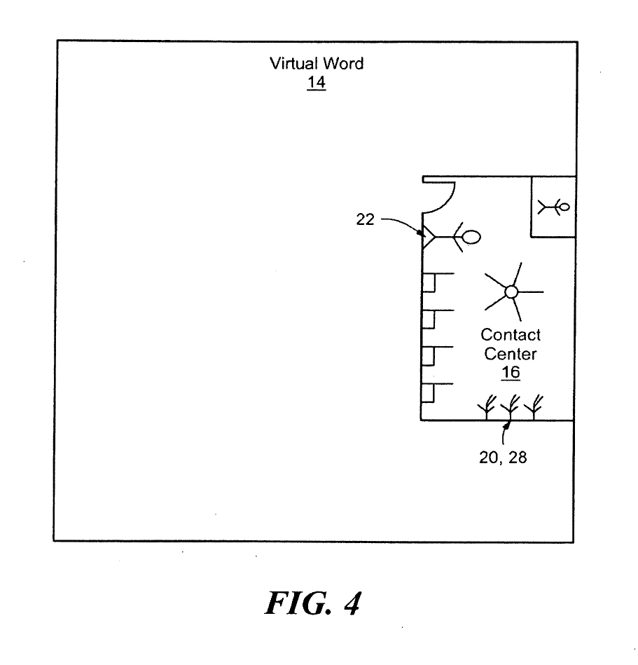

Now referring to FIG. 4, the user, represented by the avatar, has entered the virtual contact center 16. The same plants that user selected or preferred from FIG. 3, which may be stored as established environmental characteristics 20, now appear in the virtual contact center 16. Other virtual features 28 in addition to the plants may of course appear or not appear in the virtual contact center 16. For example, the appearance of the customer service agent avatar, the color of the walls, the size of the building, and the sound of the customer service agent avatar voice may be evaluated and updated to incorporate the established environmental characteristics 20.

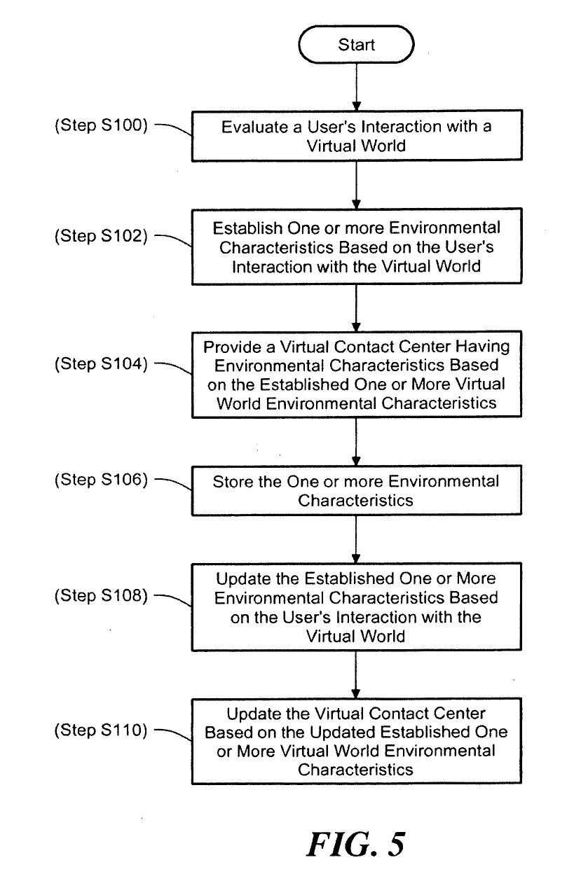

An exemplary method for creating a dynamic virtual contract in accordance with the principals of the present invention is discussed with reference to FIG. 5. A user's interaction with the virtual world 14 is observed and evaluated (Step S100). This evaluation may occur at all different times and locations within the virtual world 14. For example, initially before a user enters a virtual contact center 16, the user may interact with other avatars 22, other virtual contact centers 16, and interact with virtual features 28 of the virtual world 14, such as parks, streets, offices, or any other feature.

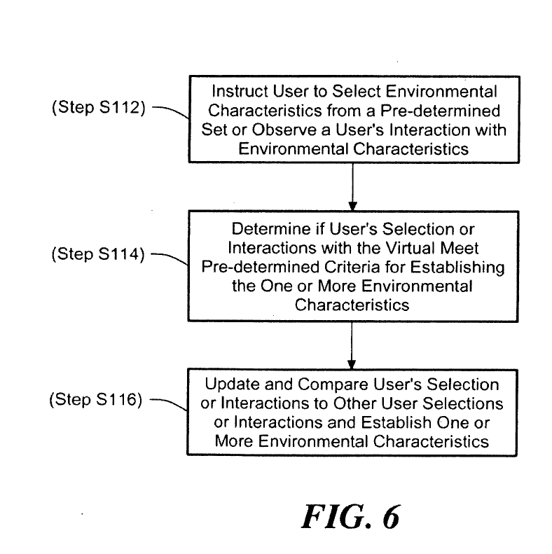

These interactions are evaluated, for example by server 12, and one or more environmental characteristics 20 are established based on the user's interaction with the virtual world 14 (Step S102). FIG. 6 is a flow chart detailing step S102. In accordance with the present invention, the environmental characteristics 20 can be established based on any desired criteria. For example, an interface through which a computing device 30 can be provided or a user can select features of the virtual world 14 (Step S112). The user may be prompted to select environmental features from a pre-determined list of, for example, avatars 22, colors 24, layouts 26, or virtual features 28. If the user had previously selected, for example, blue walls at another location within the virtual world 14, then blue walls may appear at the virtual contact center 16.

Alternatively, if the user had not selected a virtual feature 28, a determination can be made, based on predetermined criteria, which features may be established environmental characteristics 20 (Step S114). A user's interaction with a virtual contact center 16 customer service agent avatar may be observed and the user's mood or tone in response to various stimuli. The user may respond favorably to a female avatar with a soft tone and unfavorably to a male avatar with a firm tone. Interactions are monitored and observed to determine the established environmental characteristics 20 for each particular user. If the user then re-enters the same virtual contact center 16 or any other venue with a customer service representative, the method updates the customer service representative to incorporate the user's established environmental characteristics 20.

As the user gains experience in the virtual world 14, the established environmental characteristics 20 may be narrowly tailored to a specific user's behavior. For example, if during a first interaction with the virtual contact center 16 the user selected blue walls, the method may update the virtual contact center 16 to have all blue walls. However, if during a second interaction with the virtual contact center 16 the user selects yellow walls, the method may then compare the current selections with any prior selections and update the established environmental characteristics 20 (Step S116). In this example, the method may present a mix of either blue and yellow walls, green walls as the average of blue and yellow walls, or blue or yellow walls exclusively, depending on the frequency of prior selections or prior experience the user has with colors.

Now referring again to FIG. 5, as the one or more environmental characteristics 20 are established (Step S102), a virtual contact center 16 can be initialized and provided based on the established environmental characteristics 20 (Step S104). The user may also be invited into the virtual contact center 16 based on the established one or more environmental characteristics 20. For example, if one of the established environmental characteristics 20 is the user's preference for exotic plants, a virtual contact center 16 that sells plants may invite the user into that virtual contact 16. As such, target advertising for virtual world 14 users can be provided based on the established one or more environmental characteristics 20 tailored for each user.

If the user has limited or no experience with the virtual world 14 before entering the virtual contact center 16, a predetermined virtual contact center 34 is initialized with predetermined environmental characteristics 36. The predetermined environmental characteristics 36 may be, for example, based on a template or based on other virtual world 14 users' preferences. The predetermined virtual contact 34 may have an aggregate of user preferences and experiences within the virtual world 14 that may be updateable and tailored for each individual user. As the user gains experience in the virtual world 14 or in the virtual contact center 16, the predetermined environmental characteristics 36 are updated to incorporate the established one or more environmental characteristics 20.

The established environmental characteristics 20 for each virtual world 14 user can be stored (Step S106). The established environmental characteristics 20 may be stored in the database 18 and may further be organized into one or more categories. For example, avatars 22, colors 24, layouts 36, and virtual features 28, may all be stored separately for each user, or one or more these features may be merged to form a complex virtual contact center 16 that incorporates one or more of these merged features depending on the situation. For example, a user may prefer a female virtual contact center representative while experiencing one set of variables, or prefer a male while experiencing another set of variables. One or more of these environmental characteristics 20 may be stored as a categorized group that represents particular situations, and dynamically update these categories by adding or removing one or more of the environmental characteristics 20. For example, a user may prefer a female avatar with blue hair during the first interaction with the virtual world 14, but may prefer a female avatar with red hair during the second interaction with the virtual world. Moreover, as the user gains experience in the virtual world 14, the environmental characteristics may be updated in real time or updated in the database 18 (Step S108). Through several iterations, the virtual contact center 16 can be updated to incorporate the environmental characteristics for one or more situations (Step S110). The entire virtual contact center 16 may also be stored in the database 18 to provide for fast updating.

The addition of the established environmental characteristics 20 to the virtual contact 16 may improve the overall customer satisfaction at virtual contact centers 16 as the environment may be updated to reflect the user's preferences. For example, the user's mood may be detected or a user's behavior observed in real-time. If the user appears agitated, the virtual contact center 16 may be updated to present a female avatar with a soft tone if the user had responded positively that established environmental characteristic 20. As such, the virtual world 14 and the virtual contact 16 may become personalized for the individual user and adaptive to the user's selections and experience.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for creating a dynamic virtual contact center, the method including:
evaluating a user's interaction with a virtual world;
establishing one or more environmental characteristics based on the user's interaction with the virtual world; and
providing a virtual contact center having an environmental characteristic based on the established one or more virtual world environmental characteristics.

2. The method of claim 1, further including storing the one or more environmental characteristics.

3. The method of claim 1, wherein providing a virtual contact center includes providing a virtual contact center with predetermined environmental characteristics determined prior to a user's interaction with the virtual contact center.

4. The method of claim 3, further including updating the predetermined environmental characteristics to incorporate the established one or more environmental characteristics based on the user's interaction with the virtual world.

5. The method of claim 3, further including updating the virtual contact center with the established one or more environmental characteristics based on the user's interaction with the virtual world.

6. The method of claim 5, further including presenting the updated virtual contact center to the user.

7. The method of claim 1, wherein the one or more environmental characteristics includes virtual features of a virtual contact center representative.

8. The method of claim 1, wherein the one or more environmental characteristics includes virtual features of a virtual contact center structure.

9. The method of claim 1, further including inviting the user into a virtual contact center, the inviting being based at least in part on the one or more environmental characteristics.

10. The method of claim 1, further including instructing the user to select from a predetermined set of environmental characteristics.

11. The method of claim 10, wherein providing a virtual contact center includes providing a virtual contact center with environmental characteristics based at last in part on the user's selection from the predetermined set of environmental characteristics.

12. A system for creating a dynamic virtual contact center, comprising:
a central processing unit operating to provide a virtual world having a virtual contact center;
a database in operative communication with the central processing unit, the database storing one or more environmental characteristics based on a user's interaction the virtual world; and
the virtual contact center presenting one or more of the environmental characteristics based on the user's interaction with the virtual world.

13. The system of claim 12, wherein the virtual contact center presenting one or more environmental characteristics based on the user's interaction with the virtual world includes providing virtual features of a virtual contact center representative.

14. The system of claim 12, wherein the virtual contact center presenting one or more environmental characteristics based on the user's interaction with the virtual world includes providing virtual features of a virtual contact center structure.

15. A method for creating a dynamic virtual contact center, the method including:
evaluating a first interaction with a virtual world;
establishing one or more environmental characteristics based on the first interaction with the virtual world;
evaluating a second interaction with a virtual world;
updating the established one or more environmental characteristics based on the second interaction with the virtual world;
providing a virtual contact center having an environmental characteristic based on the updated established one or more environmental characteristics.

16. The method of claim 15, wherein updating the established one or more environmental characteristics based on the second interaction with the virtual worlds includes combining the established one or more environmental characteristics based on the first and second interactions with the virtual world.

17. The method of claim 15, wherein updating the established one or more environmental characteristics based on the second interaction with the virtual worlds includes replacing the established one or more environmental characteristics based on the first interaction with the virtual world with the established one or more environmental characteristics based on the second interaction with the virtual world.

18. The method of claim 15, wherein evaluating the first interaction with the virtual world includes instructing the user to select from a predetermined set of environmental characteristics.

19. The method of claim 18, wherein the predetermined set of environmental characteristics includes virtual features of a virtual contact center.

20. The method of claim 15, wherein evaluating the second interaction with the virtual world includes inviting the user into a virtual contact center, the inviting being based at least in part on the one or more environmental characteristics based on the first interaction with the virtual world.
